(19) United States
(12) Patent Application Publication
(10) Pub. No.: US 2007/0031777 A1
(43) Pub. Date: Feb. 8, 2007

(54) Multifunctional Dental Apparatus

(75) Inventors: Sean Xiaolu Wang, Wilmington, DE (US); Qun Li, Newark, DE (US)

Correspondence Address: BWT PROPERTY, INC., 19 SHEA WAY, SUITE 301, NEWARK, DE, 19713, US

(73) Assignee: BWT PROPERTY, INC., Newark, DE (US)

(21) Appl. No.: 11/462,203

(22) Filed: Aug. 3, 2006

Related U.S. Application Data
(60) Provisional application No. 60/595,763, filed on Aug. 3, 2005.

(51) Int. Cl. A61C 1/00

(52) U.S. Cl. 433/29

(57) ABSTRACT

A multifunctional dental apparatus comprising dental lasers and light emitting diodes (LEDs) is disclosed for performing photo treatment on an oral site. The dental lasers and LEDs share a unified user interface for operation control and monitoring. The dental lasers and LEDs can work in a cooperative manner with their light beams delivered to the treatment site through a common output port.

### REFERENCE TO RELATED APPLICATIONS

This application claims an invention which was disclosed in Provisional Patent Application No. 60/595,763, filed Aug. 3, 2005, entitled “Self-contained Multifunctional Dental Instrument”. The benefit under 35 USC §119(e) of the above mentioned United States Provisional Applications is hereby claimed, and the aforementioned application is hereby incorporated herein by reference.

### FIELD OF THE INVENTION

This invention generally relates to a dental apparatus and more specifically to a multifunctional dental apparatus comprising dental lasers and LEDs.

### BACKGROUND

Photo treatment is becoming a widely deployed technique in dentistry. Detailed applications include incision, ablation, vaporization, and/or coagulation of oral soft tissue, photo dynamic therapy, curing of dental resin, teeth whitening, surgical illumination and/or sterilization. The light sources used in photo treatment include a variety of lamps, lasers and light emitting diodes (LEDs), which have different operation requirements that may be confusing for a dentist. It is thus highly desirable that a unified photo treatment apparatus is provided to handle all the above mentioned tasks.

Some examples of multifunctional dental apparatus have been disclosed in U.S. Pat. Nos. 4,516,195, 5,334,016, and 5,928,220, and PCT patent application No. WO 98/44861 and WO 01/10327.

In U.S. Pat. No. 4,516,195, Gonser discloses a multi-function dental operating light source that provides illumination light beam and photo curing light beam in the same module. The light source comprises a tungsten halogen lamp and a series of optical filters mounted on a turntable for wavelength selection. The functions of the disclosed light source are limited to illumination and photo curing purposes. In U.S. Pat. No. 5,928,220, Shimoji discloses a cordless diode-pumped solid-state laser unit for oral surgery, sterilization and curing of dental materials. The emitting wavelengths of the lasers are around 473 nm and 355 nm, which are not efficient for laser surgery as these wavelengths are far away from the absorption bands of water.

In PCT patent application No. WO 01/10327, Neuberger discloses a dental scaling device that is combined with a laser source to provide sterilization and/or photodynamic therapy in conjunction with cleaning and scaling treatments. In U.S. Pat. No. 5,334,016, Goldsmith et al. discloses a dental apparatus that combines an air abrasive system and a laser system. In PCT patent application No. WO 98/44861, which is a continuation of U.S. Pat. No. 5,334,016, Gallant et al. discloses a multipurpose dental apparatus that include pneumatic drills, a dental laser, an air abrasive system, a laryngoscope, and a plasma arc curing light. In these patents, although various dental tools are incorporated into the same housing to form a multifunctional dental apparatus, the dental tools are physically separated into different chambers and driven by individual circuit boards since the dental tools utilize different physical mechanisms and their power consumption vary significantly. In consequence, the whole dental apparatus is complicated in structure and cumbersome in physical size.

There has been no previously known dental apparatus that integrates dental lasers and LEDs in the same system for performing multiple photo treatments including soft tissue surgery, photo curing, sterilization, photo therapy, and teeth whitening. Such integration is advantages in the following aspects. (a) The lasers and LEDs have complementary beam properties so that they can work cooperatively. The laser beam has high intensity and small divergence angle, which is suitable for surgery and aiming purposes. The LED beam has relatively large divergence angle, which is suitable for photo curing, illumination, photo therapy, and sterilization purposes. (b) The dental lasers and LEDs have similar operation parameters so that they can be controlled by a unified user interface. In certain cases, the dental lasers and LEDs can even share a common driver/control circuit board. (c) The laser beam and LED beam can be delivered through a common light guide.

### SUMMARY OF THE INVENTION

It is the overall goal of the present invention to provide a highly integrated multifunctional dental apparatus with compact size and light weight. The multifunctional dental apparatus comprises dental lasers for incision, excision, ablation, vaporization, and coagulation of oral soft tissue, sterilization, curing of dental resin, teeth whitening, and/or low light level laser therapy. It also comprises dental LEDs for oral photo therapy, curing of dental resin, teeth whitening, illumination, and/or sterilization. The dental lasers and LEDs share a unified user interface for control and monitoring purposes. In certain cases, they may utilize a common driver/control circuit board and a common light guide for beam delivery.

It is another goal of the present invention to replace the halogen lamp or plasma arc curing light with an LED or laser curing light that has better wall-plug efficiency. Unlike the broadband halogen lamp or plasma arc curing light, the LED or laser light produces a narrowband emission that matches well with the absorption spectrum of the dental resin. As a result, the LED or laser light can produce the same curing result with much lower power consumption.

It is yet another goal of the present invention to incorporate into the dental unit multiple dental lasers/LEDs with a variety of emission wavelengths, which wavelengths match with the absorption band of different oral tissues and/or dental materials.

It is yet another goal of the present invention to apply the output beams of multiple dental lasers/LEDs simultaneously onto the treatment site and utilize a control unit to regulate the relative intensity of the multiple lasers/LEDs to achieve the optimum photo treatment result.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 shows an exemplary multifunctional dental apparatus comprising one infrared laser diode and one blue LED.

FIG. 2 shows another embodiment of the dental apparatus comprising three laser diodes and three LEDs with different emission wavelengths.

FIG. 3 shows some methods for combining the beams of lasers/LEDs with different wavelengths.

FIG. 4 shows another embodiment of the dental apparatus in which the dental lasers and LEDs share a common output port and light guide.

FIG. 5 shows some methods for combining laser and LED beams.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a multifunctional dental apparatus. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

FIG. 1 shows an exemplary embodiment of the multifunctional dental apparatus. The dental apparatus 100 comprises an infrared laser diode (LD) 101, such as a 980 nm laser diode, for oral soft tissue surgery, and a blue LED 102, such as a 470 nm LED, for dental resin curing. The laser diode 101 and the LED 102 are enclosed in a common housing 103. Since the laser diode 101 and the LED 102 are both semiconductor devices with similar drive voltage and current requirement, a common driver/control circuit board 104 is used to provide electrical power and control the output intensity of the two dental units 101 and 102. The output beams of the laser diode 101 and the LED 102 are first collected by a group of lenses 105, 106 and coupled into light guides 107, 108, and then delivered to the treatment site through output port 109, 110, respectively. The light guides 107, 108 can be liquid light guides or optical fibers/fiber bundles made of various materials. The output beam from the light guide 107, 108 may be focused and collimated by optical lenses 111, 112, respectively, before delivered to the treatment site. The two dental units 101, 102 share a common front panel 113 as a unified user interface for operation control and monitoring. The laser diode 101, LED 102 and front panel 113 are connected to the driver/control circuit board 104 through electrical wires 114. In a slight variation of the embodiment, the output light guides 107 and/or 108 may be omitted. The laser diode 101 and/or the LED 102 can be positioned outside the housing 103 as handpieces connected with electrical wires 114 for direct targeting the treatment site.

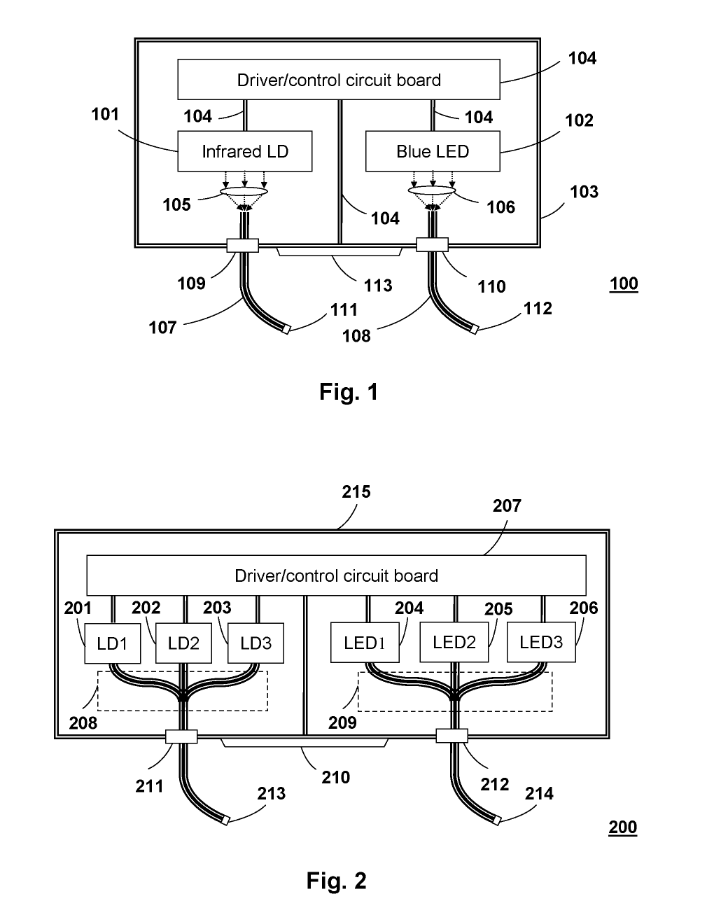

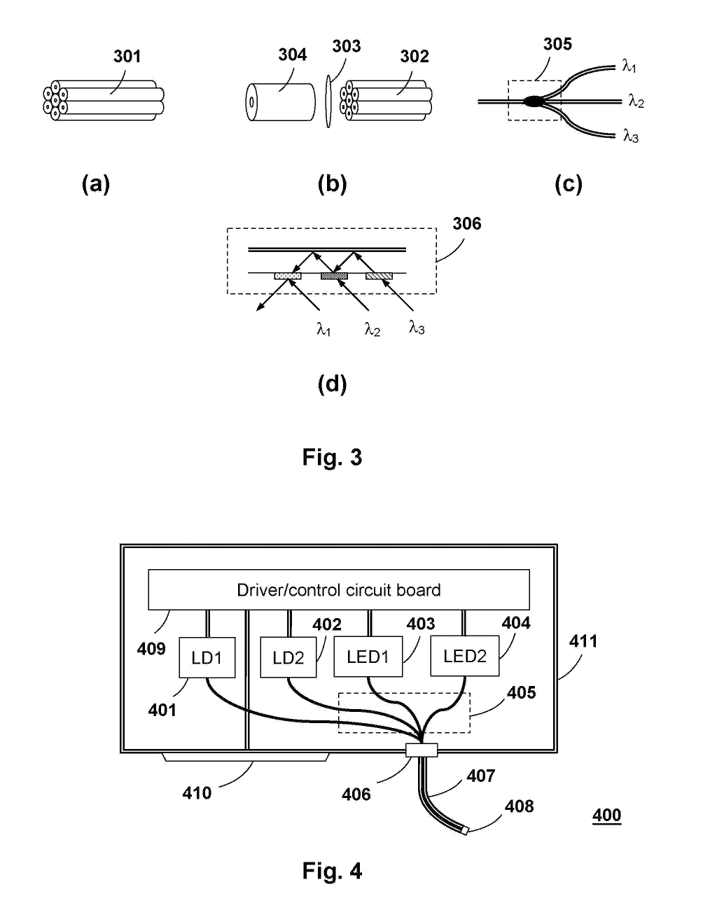

Another exemplary embodiment of the present invention is shown in FIG. 2. In this embodiment, the dental apparatus 200 comprises three laser diodes 201, 202, 203 with different central wavelengths. The 980 nm laser diode 201, whose wavelength matches with the absorption band of water, is mainly used for incision, excision, ablation and vaporization of oral tissue. The 810 nm laser diode 202, with its emission wavelength matching with the absorption band of hemoglobin and oxyhemoglobin, is mainly used for coagulation. The laser diode 203 has a visible emission wavelength which is used for aiming and illumination purposes. The lasers 201, 202, 203 may be used for other photo treatments. For example, the visible laser may be a 650 nm laser used for photo dynamic therapy. The lasers can also be used to activate peroxide for teeth whitening. The beams of the three lasers are combined by a beam combiner 208 in a manner shown in FIGS. 3 (a), (b) (c), or (d).

In FIG. 3 (a), the light from the laser diodes is first coupled into individual optical fibers 301 and the optical fibers are then combined to form a fiber bundle to deliver laser beam to the treatment site. In FIG. 3 (b), the laser light is first coupled into fiber bundles 302 in a similar way as in FIG. 3 (a). The combined laser light is then coupled into another optical fiber 304 (or other kinds of light guides) with larger core diameter through a lens 303 for light delivery. In FIG. 3 (c), the light from the laser diodes are first coupled into optical fibers and a fiber coupler or a fiber wavelength multiplexer 305 is then used to combine the light from different lasers. In FIG. 3 (d), the laser beams are first collimated and then combined by a thin film wavelength multiplexer 306.

The combined laser beam is delivered through output port 211 and focused/collimated by a lens 213 to achieve the desired intensity and beam divergence angle. The relative intensity of the three laser diodes 201, 202, 203 can be adjusted through the driver/control circuit board 207 to achieve the optimum photo treatment result. The three LEDs 204, 205, 206 employed in this embodiment have emission wavelengths at 470 nm, 405 nm and in the ultraviolet (UV) range, respectively. The 470 nm LED 204 and 405 nm LED 205 are used for curing dental resins with corresponding absorption wavelengths. The UV LED 206 is used for sterilization and ulcer treatment. The light beams of the LEDs 204, 205, 206 can be combined by a beam combiner 209 using similar methods as shown in FIG. 3. The combined LED beam is delivered through output port 212 and focused/collimated by a lens 214 to achieve the desired intensity and beam divergence angle. The output intensity of the three LEDs can be adjusted through the driver/control circuit board 207. A front panel 210 is used as a unified user interface for controlling and monitoring the operation of the dental lasers and LEDs. The dental lasers 201, 202, 203 and LEDs 204, 205, 206 are enclosed in a common housing 215. In a slight variation of the embodiment, the beam combiner 208 and/or 209 and the corresponding light guides may be omitted. The laser diodes 201, 202, 203 and/or the LEDs 204, 205, 206 can be positioned outside the housing 215 as handpieces for direct targeting the treatment site.

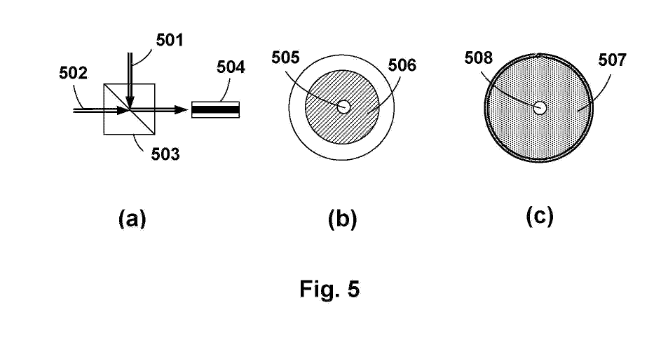

In yet another embodiment of the present invention as shown in FIG. 4, the dental apparatus 400 comprise two laser diodes 401, 402 and two LEDs 403, 404 enclosed in a common housing 411. The light beams from the laser diodes 401, 402 and the LEDs 403, 404 are combined by a beam combiner 405 and delivered from a common output port 406 and a common light guide 407. The output light beam can be further focused and collimated by an optical lens 408 for beam intensity and divergence angle control. In this embodiment, the laser diodes and LEDs may function cooperatively to achieve the optimum photo treatment result. For example, the laser diodes may have emission wavelength at 980 nm and 810 nm for oral tissue surgery. One of the LED may be a white colored LED for illumination, while the other LED may be a UV LED for sterilization purposes during the laser surgery process. The laser beam and the LED beam can be combined in a manner similar to that shown in FIG. 3 (a), where the laser beam and the LED beam are delivered by different light guides that are bundled together. The laser beam and the LED beam can also be combined in a manner as shown in FIGS. 5 (a), (b) or (c).

In FIG. 5 (a), the laser beam 501 and LED beam 502 are combined by a beam splitter 503 and coupled into an optical fiber or liquid light guide 504. In FIG. 5 (b), a double-cladding fiber is used to deliver and combine the laser and LED beam, where the laser beam propagates in the inner core region 505 and the LED beam propagates in the outer core region 506. Similarly, a liquid guide 507 with an embedded optical fiber 508 as shown in FIG. 5 (c) can be used, where the liquid guide 507 delivers the LED beam and the embedded optical fiber 508 delivers the laser beam. The intensity and on/off status of each laser and LED unit can be controlled by the driver/control circuit board 409 through a common front panel 410 to adapt for different application requirements. In a slight variation of the embodiment, the beam combiner 405 and the corresponding light guide 407 may be omitted. The laser diodes 401, 402 and the LEDs 403, 404 can be assembled together into a handpiece unit for direct targeting the treatment site. The handpiece unit is connected with the driver/control circuit board 409 through electrical wires.

In the foregoing specification, specific embodiments of the present invention have been described. However, one of ordinary skill in the art appreciates that various modifications and changes can be made without departing from the scope of the present invention as set forth in the claims below. For example, other type of lasers such as CO₂ lasers, diode/lamp-pumped solid-state lasers, can also be used as the dental laser. The blue LEDs used for curing of dental resin can be replaced by blue lasers. The functions of the dental lasers and LEDs are not limited to the above mentioned examples. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A multifunctional dental apparatus, comprising:
a plurality of lasers and light emitting diodes (LEDs) for performing photo treatment on an oral site; and
a unified user interface for monitoring and controlling said dental lasers and LEDs.

2. The dental apparatus of claim 1, wherein the dental lasers and LEDs work in a cooperative manner.

3. The dental apparatus of claim 1, wherein the light of the lasers and LEDs is delivered to the treatment site through a common output port.

4. The dental apparatus of claim 1, wherein the light of the lasers and LEDs is delivered to the treatment site through separate output ports.

5. The dental apparatus of claim 1, wherein the light of the lasers and LEDs is delivered to the treatment site through at least one light guide.

6. The dental apparatus of claim 1, wherein the dental lasers and LEDs have multiple emission wavelengths, and wherein said wavelengths match with the absorption wavelengths of different oral tissues and dental resins.

7. The dental apparatus of claim 1, wherein part of the lasers and/or LEDs are used for aiming and/or illumination purposes.

8. A method for producing a multifunctional dental apparatus, the method comprising the steps of:
providing a plurality of lasers and light emitting diodes (LEDs) for performing photo treatment on an oral site; and
providing a unified user interface for monitoring and controlling said dental lasers and LEDs.
